(19) United States
(12) Patent Application Publication
(10) Pub. No.: US 2007/0053496 A1
(43) Pub. Date: Mar. 8, 2007

(54) X-ray generating method and X-ray generating apparatus

(75) Inventor: Noriyoshi Sakabe, Tsukuba-shi (JP)

Correspondence Address: OLIFF & BERRIDGE, PLC, P.O. BOX 19928, ALEXANDRIA, VA, 22320, US

(73) Assignees: NORIYOSHI SAKABE, Tsukuba-shi (JP); KIWAKO SAKABE, Tsukuba-shi (JP)

(21) Appl. No.: 11/509,631

(22) Filed: Aug. 25, 2006

(30) Foreign Application Priority Data
Sep. 2, 2005 (JP) 2005-255022

(51) Int. Cl. H01J 35/10

(52) U.S. Cl. 378/144

(57) ABSTRACT

Energy beams are irradiated onto a target from an energy source to melt a portion of said target to which the energy beams are irradiated so that an X-ray is generated from the target by the irradiation of the energy beam under the condition that the surface roughness of the target due to the irradiation of the energy beams is diminished.

### FIELD OF THE INVENTION

This invention relates to an X-ray generating method and an X-ray generating apparatus for generating an X-ray with ultrahigh intensity.

### DESCRIPTION OF THE BACKGROUND ART

In X-ray diffraction measurement, it may be required to irradiate an X-ray with as high intensity as possible onto a sample. In this case, a conventional rotating anticathode type X-ray generating apparatus would be employed for the X-ray diffraction measurement.

The rotating anticathode type X-ray generating apparatus is configured such that electron beams are irradiated onto the outer surface of the columnar anticathode (target) in which a cooling medium is flowed while the anticathode is rotated at high speed. In comparison with a stationary target type X-ray generating apparatus, the rotating anticathode type X-ray generating apparatus can exhibit extreme cooling efficiency because the irradiating position of the electron beams on the anticathode changes with time. Therefore, in the rotating anticathode type X-ray generating apparatus, the electron beams can be irradiated onto the anticathode in large electric current, thereby generating an X-ray with high intensity.

### SUMMARY OF THE INVENTION

However, when the electron beams are irradiated onto a given area of a target such as a rotating anticathode, the area of the target is heated, but when the electron beams are shifted and irradiated onto another area of the target, the previous heating area of the target is cooled. In this point of view, the target is heated and cooled due the electron beam irradiation and the target shifting so that the surface of the target can become roughness due to the thermal stress of the target. If the electron beams are irradiated successively on the target with the rough surface, generated X-rays generated by the electron beams are absorbed by the concave-convex portions of the target surface so that the intensity of the X-ray to be generated can be lowered.

In order to maintain the intensity of the X-ray to be generated constantly, therefore, it is required that the intensity of the electron beam is lowered from the beginning so that the intensity of the X-ray to be generated can be lowered constantly so as not to render the target surface rough.

The present invention is established on the basis of the above-mentioned conventional background, and it is an object of the present invention to generate an X-ray with high intensity constantly even though energy beams such as electron beams are irradiated onto a target in high intensity under the condition that the target surface is not rendered rough due to the thermal stress from the energy beam irradiation.

Means for Solving the Problem

In order to achieve the object, this invention relates to a method for generating an X-ray, comprising the steps of: irradiating energy beams onto a target from an energy source to melt a portion of the target to which said energy beams are irradiated; and generating an X-ray from the target by the irradiation of the energy beam under the condition that the surface roughness of the target due to the irradiation of the energy beams is diminished.

This invention also relates to an apparatus for generating an X-ray, comprising: a target for generating an X-ray by the irradiation of energy beams; and an energy source for generating the energy beams, wherein the energy source is configured so that the energy beams are irradiated onto the target so as to melt a portion to which the energy beams are irradiated, and the X-ray is generated from the target under the condition that the surface roughness of the target due to the irradiation of the energy beams is diminished.

In the past, in the X-ray generation from energy beam irradiation such as electron beam irradiation onto a target such as a rotating anticathode, the energy beam irradiation is carried out until the irradiating area of the target is heated around the melting point of the target so as not to melt the irradiating area of the target. Also, even though the irradiating area of the target is melted, the melting area is reduced in a point as small as possible within the irradiating area of the target.

In the present invention, in contrast, the energy beams are irradiated onto the target in an intensity as high as possible out of the above-mentioned conventional technique so that the irradiating area of the energy beams can be melted. In this case, the melting area of the target corresponds to the irradiating area of the energy beams so that the melting area of the target is a smaller area than the whole size of the target. In this point of view, the splash of the melting area of the target can be repressed as small as possible.

Then, since the energy beams are irradiated on the target in high intensity, an X-ray with high intensity can be generated from the target. Moreover, since the energy beams are configured such that the irradiating area of the target by the energy beams can be melted, the irradiating area of the target can be melted successively by the scanning of the energy beams. In this case, the target surface can be planed commensurate with the successive melting of the target from the energy beam irradiation so that the X-ray generated from the energy beam irradiation can not be absorbed by the concave-convex portions of the target. As a result, the intended X-ray can be generated constantly in high intensity over a prolonged period of time.

In a preferred embodiment, the target is composed of a rotating anticathode so that the energy beams are irradiated onto an area positioned against the centrifugal force from the rotation of the rotating anticathode. In this case, even though the target is melted partially from the irradiation of the energy beams, the outer splash of the melting area of the target can be repressed effectively and efficiently. Also, since the irradiating position of the energy beam can be shifted easily, the intended X-ray can be generated constantly in high intensity.

In this case, the rotating anticathode may have a cylindrical portion which is provided along the periphery of the rotating anticathode so that the energy beams are irradiated onto the inner wall of the cylindrical portion of the anticathode. In this case, since the target melting occurs at the inner wall of the cylindrical portion of the rotating anticathode, the outer splash of the melting area of the rotating anticathode due to the energy beam irradiation can be repressed more effectively.

The side wall of the cylindrical portion of the rotating anticathode can be inclined inwardly so that the outer splash of the melting area of the rotating anticathode due to the energy beam irradiation can be repressed more effectively. In contrast, the side wall of the cylindrical portion of the rotating anticathode can be inclined outwardly so that the intended X-ray can be taken easily out of the rotating anticathode under the condition that the outer splash of the meting area of the rotating anticathode can be repressed.

Then, the irradiating area of the energy beams in the rotating anticathode can be formed in a V-shaped ditch or a U-shaped ditch so that the outer splash of the melting area of the target due to the energy beam irradiation can be repressed effectively. In this case, the V-shaped irradiating area or the U-shaped irradiating area can be formed in such a shape as the centrifugal force affects the melting area of the target during the rotation of the rotating anticathode. In this case, the target surface roughness of the rotating anticathode can be repressed effectively so that the intended X-ray can be generated constantly in high intensity.

In another preferred embodiment of the present invention, the area around the energy beam irradiating area in the target is made of a material with higher melting point and/or higher thermal conductivity than the target itself. In this case, the cooling efficiency of the target can be enhanced entirely and the deformation of the target can be repressed efficiently so that the intended X-ray can be generated constantly in high intensity over a prolonged period of time.

Concretely, the target for generating the intended X-ray is configured such that a cooling water is flowed along the backside of the energy beam irradiating area of the target for the constant cooling of the target. However, if the intensity of the energy beams is set too high and the irradiating period of the energy beams is set too long, the energy beams may penetrate though the target so that the cooling water is leaked to the X-ray generating side, thereby rendering the X-ray generating apparatus with the rotating anticathode malfunction.

In this point of view, the target can be a double structured target which is composed of the target and the high melting point and/or high thermal conductivity substance which is provided at the backside of the target so that the energy beams are irradiated onto the target and the cooling medium such as a cooling water is flowed along the backside of the substance. In this case, the energy beams can not penetrate through the target so that the cooling medium can not be leaked to the X-ray generating side, originated from the large heat resistance due to the high melting point of the substance and the large cooling performance due to the high thermal conductivity of the substance.

As described above, according to the present invention can be provided an X-ray generating method and an X-ray generating apparatus which can generate an X-ray with high intensity from a target under the condition that the target surface roughness due to thermal stress can be repressed even though energy beams such as electron beams are irradiated onto the target in high intensity.

### BRIEF DESCRIPTION OF THE DRAWINGS

For better understanding of the present invention, reference is made to the attached drawings, wherein

FIG. 1 is a cross sectional view illustrating an X-ray generating apparatus according to the present invention, and

FIG. 2 is an enlarged cross sectional view illustrating a part of the X-ray generating apparatus illustrated in FIG. 1.

### DESCRIPTION OF THE PREFERRED EMBODIMENTS

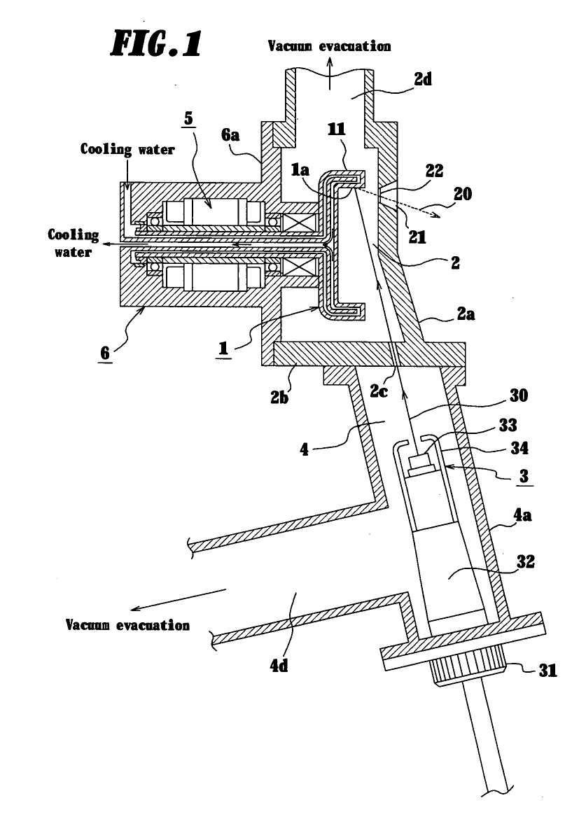

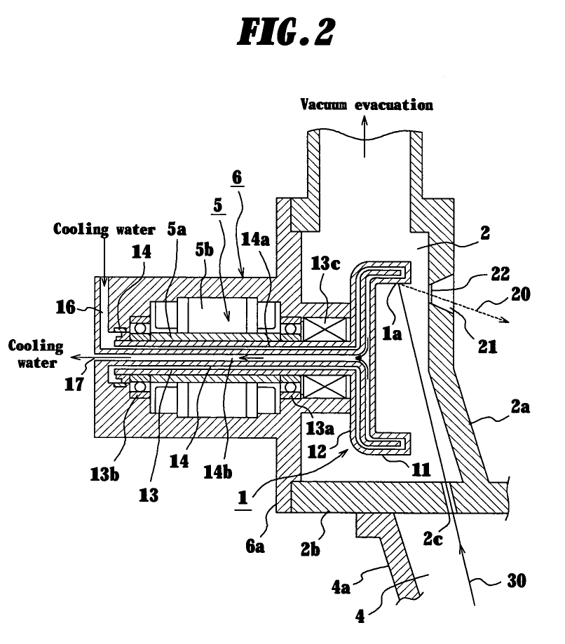

This invention will be described in detail with reference to the accompanying drawings. FIG. 1 is a cross sectional view illustrating an X-ray generating apparatus according to the present invention, and FIG. 2 is an enlarged cross sectional view illustrating a part of the X-ray generating apparatus illustrated in FIG. 1.

The X-ray generating apparatus includes an anticathode chamber 2 for accommodating a rotating anticathode 1, a cathode chamber 4 for accommodating a cathode 3 and a rotation driving chamber 6 for accommodating a driving motor 5 for rotating the anticathode 1 which are located in the vicinity of one another and separated from one another by air-tight members 2a, 4a and 6a. At a separating wall 2b for separating the anticathode chamber 2 and the cathode chamber 4 is formed a small hole 2c for passing electron beams 30 to be emitted from the cathode through the separating wall 2b. Then, at the anticathode chamber 2 and the cathode chamber 4 are provided vacuum outlets 2d and 4d, respectively to which vacuum pumps (not shown) are connected. Herein, a tube is provided at the hole 2c.

The rotating anticathode 1 includes a cylindrical portion 11 made of Cu or the like, a circular plate 12 formed so as to close the one opening of the cylindrical portion 11, and a rotating shaft 13 with a center shaft shared with the cylindrical portion 11 and the circular plate 12 which are integrally formed. The interiors of the cylindrical portion 11, the circular plate 12 and the rotating shaft 13 are formed in air hole so that a cooling water can be flowed in the interiors thereof. The electron beams are irradiated onto the inner wall of the cylindrical portion 11.

The rotating shaft 13 is supported rotatably by a pair of bearings 13a and 13b which are provided in the rotation driving chamber 6. Around the rotating shaft 13 is provided a rotor 5b for the driving motor 5 and at the air-tight member 6a in the rotation driving chamber 6 is provided a stator 5a for rotating the rotor 5b.

At the root of the rotating shaft 13 near the circular plate 12 is provided a rotating shaft-sealing member 13c for maintaining the interior of the anticathode chamber 2 in vacuum by arranging the rotating shaft 13 and the air-tight member 6a under air-tight condition.

In the rotating anticathode 1 is inserted a stationary separating member 14 for flowing the cooling water along the inner wall of the electron beam irradiating portion 1a. The stationary separating member 14 is formed in a cylindrical shape, enlarged along the shape of the circular shape 12 and elongated short of the inner wall of the cylindrical portion 11.

In other words, the stationary separating member 14 divides the interior space of the rotating anticathode 1 so as to be a double tube structure. The outer tube 14a of the double tube structure is communicated with a cooling water inlet 16. The cooling water, which is introduced from the inlet 16, is introduced into the inner tube 14b of the double tube structure so as not to be leaked to the accommodating space where the bearings 13a, 13b and the driving motor 5 are provided.

The cooling water, which is introduced from the inlet 16, is flowed in the outer tube 14a of the double tube structure, returned from the inner wall of the cylindrical portion 11 and flowed in the inner tube 14b of the double tube structure. In this case, the inner wall of the electron beam irradiating portion 1a is cooled by the cooling water, and the remnant cooling water is flowed in the inner tube 14b and discharged from the outlet 17.

At the air-tight member 2a in the vicinity of the electron beam irradiating portion 1a of the rotating anticathode 1 is provided an X-ray window 21 for taking out an X-ray 20 generated by the irradiation of the electron beams 30 onto the electron beam irradiating portion 1a. At the X-ray window is provided an X-ray transmitting film 22 made of a material which can pass the X-ray therethrough such as Be so that the intended X-ray can be taken out of the apparatus with maintaining the vacuum condition of the anticathode chamber 2.

The cathode 3 includes an insulating structured member 32, a filament 33 and a wehnelt 34 and is configured so as to generate and irradiate the electron beams 30 onto the anticathode 1 by supplying a high voltage and a filament electric power which are introduced from a high voltage introducing portion 31.

In the X-ray generating apparatus as described above, the cooling water is introduced from the inlet 16, and the rotating anticathode 1 is rotated at high speed by the driving motor 5, and the electron beams 30 are irradiated onto the electron beam irradiating portion 1a of the anticathode 1 from the cathode, thereby generating the X-ray 20. In this case, the intensity of the electron beams 30 are set to a one which can melt the electron beam irradiating portion 1a.

According to the X-ray generating apparatus as described above, since the rotating anticathode 1 is rotated at high speed by the driving motor 5, the electron beam irradiating portion 1a is successively changed so that the melting portion of the anticathode can be successively changed. As a result, the surface of the anticathode 1 can be planed through the successive melting of the anticathode 1 so that the surface of the anticathode 1 can be maintained plane during the irradiation of the electron beams 30. In other words, since the surface of the anticathode 1 can not be roughed, the X-ray to be generated can not be absorbed by the concave-convex portions of the surface of the anticathode

Then, since the intensity of the electron beams 30 is set to the one which can melt the electron beam irradiating portion 1a of the anticathode 1, the intended X-ray can be generated in high intensity. As a result, the intended X-ray can be generated constantly over a prolonged period of time on the synergy of the prevention of the X-ray absorption at the concave-convex portions of the surface of the anticathode 1.

In this embodiment, according to the melting of the electron beam irradiating portion 1a at the surface of the anticathode 1, the surface roughness of the anticathode surface can be reduced to 1 μm or below, particularly to 100 nm or below as surface mean roughness. In this way, according to this embodiment, the surface of the anticathode 1 can be maintained plane over a prolonged period of time. According to a conventional technique, in contrast, the surface of the anticathode 1 can be reduced only within a range of 2-10 μm as surface mean roughness. In comparison with the conventional technique and this embodiment according to the present invention relating to surface roughness, since this embodiment can exhibit superior surface roughness, this embodiment can generate the X-ray in high intensity constantly.

In this embodiment, since the electron beam irradiating portion 1a is set on the inner wall of the cylindrical portion 11 of the anticathode 1, the inner wall of the cylindrical portion 11 is melted partially. In this case, since the electron beam irradiating portion 1a, which is melted, is located against the centrifugal force from the rotation of the anticathode 1, the outer splash of the melting area of the anticathode 1 can be prevented.

In this embodiment, a special processing is not carried out for the cylindrical portion 11 of the anticathode 1 so that the electron beam irradiating portion 1a is positioned on the inner wall of the cylindrical portion 11 under the condition that the side wall of the cylindrical portion 11 is set parallel to the rotation axis. However, the inner wall of the cylindrical portion 11 can be inclined by several tenths of one degree through several tens degrees.

Concretely, the inner wall of the cylindrical portion 11 can be inclined inwardly toward the rotation axis by several tenths of one degree through several tens degrees. In this case, the electron beam irradiating portion 1a, which is melted, can be located more stably on the inner wall of the cylindrical portion 11 against the centrifugal force. As a result, the outer splash of the electron beam irradiating portion 1a can be prevented more effectively. In contrast, the inner wall of the cylindrical portion 11 can be inclined outwardly from the rotation axis by several tenths of one degree through several tens degrees. In this case, the intended X-ray can be taken easily out of the apparatus under the condition that the outer splash of the electron beam irradiating portion 1a melted can be prevented.

If the electron beam irradiating portion 1a is formed such that the cross sectional shape becomes a V-shaped ditch or a U-shaped ditch, the outer splash of the electron beam irradiating portion 1a can be prevented more effectively. In this case, the width and depth of the V-shaped ditch or the U-shaped ditch are determined so that the intended X-ray can be taken easily out of the apparatus. Moreover, if the ditch is formed in the same shape as the melting area, that is, the electron beam irradiating portion 1a is deformed by the centrifugal force, the surface deformation of the electron beam irradiating portion 1a through melting can be repressed.

In addition, if the electron beam irradiating portion 1a is made of a target material in dependence on the kind of X-ray to be generated and the area around the electron beam irradiating portion 1a is made of a material with higher melting point and/or higher thermal conductivity than the target material, the cooling efficiency of the anticathode 1 can be enhanced entirely and the intended X-ray can be generated constantly over a prolonged period of time.

Furthermore, the anticathode 11, particularly the cylindrical portion 11 to which the electron beams 30 are irradiated may be made of the target material and the high melting point and/or high thermal conductivity substance may be provided at the backside of the target material so that the cylindrical portion 11 can be a double structure. In this case, while the intended X-ray is generated by the irradiation of the electron beams 30 onto the cylindrical portion 11, the cylindrical portion 11 is cooled by a cooling medium so that the electron beams 30 can not penetrate through the cylindrical portion 11 on the synergy effect of the large heat resistance and the large cooling effect which are originated from the high melting point and/or the high thermal conductivity of the substance provided at the backside of the target material. As a result, the cooling medium can not be leaked.

As the cooling medium can be exemplified a cooling water and a cooling oil.

In this embodiment, since the electron beam irradiating portion 1a is melted, the metallic vapor pressure may increase by the melting of the target material in the anticathode chamber 2, thereby contaminating the X-ray transmitting window 22. In this case, a rolled protective film, which is made of Ni, BN, Al or mylar against recoil electrons and exchangble, may be provided in front of the X-ray transmitting window 22. The rolled protective film is tensed between the supplying roll and the winding roll which are provided inside the X-ray window 21. The thickness of the protective film is appropriately adjusted in view of the recoil electron energy and the X-ray absorption.

In this embodiment, although the electron beams are employed as the energy beams, other energy beams such as laser beams and ion beams may be employed.

Although the present invention was described in detail with reference to the above examples, this invention is not limited to the above disclosure and every kind of variation and modification may be made without departing from the scope of the present invention.

What is claimed is:

1. A method for generating an X-ray, comprising the steps of:
irradiating energy beams onto a target from an energy source to melt a portion of said target to which said energy beams are irradiated; and
generating an X-ray from said target by the irradiation of said energy beam under the condition that the surface roughness of said target due to the irradiation of said energy beams is diminished.

2. The generating method as defined in claim 1, wherein the surface roughness of said target is reduced within a range of 1 μm or below as surface mean roughness.

3. The generating method as defined in claim 1, wherein said energy beams are electron beams.

4. The generating method as defined in claim 1, wherein said target includes a rotating anticathode so that said energy beams are irradiated onto a portion of said rotating anticathode against a centrifugal force from the rotation of said rotating anticathode.

5. The generating method as defined in claim 4, wherein said rotating anticathode includes a cylindrical portion provided along a periphery of said rotating anticathode so that said energy beams are irradiated onto an inner wall of said cylindrical portion.

6. The generating method as defined in claim 5, wherein a side wall of said cylindrical portion is inclined inwardly toward a center axis of said rotating anticathode so that the outer splash of said portion of said target to which said energy beams are irradiated is repressed through the melting of said portion.

7. The generating method as defined in claim 5, wherein a side wall of said cylindrical portion is inclined outwardly from a center axis of said rotating anticathode so that said X-ray can be taken easily out of said target.

8. The generating method as defined in claim 4, wherein said portion to which said energy beams are irradiated is formed in a V-shaped ditch or a U-shaped ditch.

9. The generating method as defined in claim 8, wherein said V-shaped ditch or said U-shaped ditch is formed in the same shape as said centrifugal force affects said portion under melting to which said energy beams are irradiated.

10. The generating method as defined in claim 1, further comprising the step of, in said target, making an area around said portion to which said energy beams are irradiated from a substance with higher melting point and/or higher thermal conductivity than a target material contributing the generation of said X-ray.

11. The generating method as defined in claim 4, further comprising the step of, in said target, making an area around said portion to which said energy beams are irradiated from a substance with higher melting point and/or higher thermal conductivity than a target material contributing the generation of said X-ray.

12. The generating method as defined in claim 10, wherein said target is a double structured target composed of said target material and said substance with higher melting point and/or higher thermal conductivity than said target material and which is provided at a backside of said target material so that a cooling medium is flowed along said backside of said substance.

13. The generating method as defined in claim 11, wherein said target is a double structured target composed of said target material and said substance with higher melting point and/or higher thermal conductivity than said target material and which is provided at a backside of said target material so that a cooling medium is flowed along said backside of said substance.

14. An apparatus for generating an X-ray, comprising:
a target for generating an X-ray by the irradiation of energy beams; and
an energy source for generating said energy beams,
wherein said energy source is configured so that said energy beams are irradiated onto said target so as to melt a portion to which said energy beams are irradiated, and said X-ray is generated from said target under the condition that the surface roughness of said target due to the irradiation of said energy beams is diminished.

15. The generating apparatus as defined in claim 14, wherein the surface roughness of said target is reduced within a range of 1 μm or below as surface mean roughness.

16. The generating apparatus as defined in claim 14, wherein said energy source is an electron beam source so that said energy beams can be electron beams.

17. The generating apparatus as defined in claim 14, wherein said target includes a rotating anticathode so that said energy beams are irradiated onto a portion of said rotating anticathode against a centrifugal force from the rotation of said rotating anticathode.

18. The generating apparatus as defined in claim 17, wherein said rotating anticathode includes a cylindrical portion provided along a periphery of said rotating anticathode so that said energy beams are irradiated onto an inner wall of said cylindrical portion.

19. The generating apparatus as defined in claim 18, wherein a side wall of said cylindrical portion is inclined inwardly toward a center axis of said rotating anticathode so that the outer splash of said portion of said target to which said energy beams are irradiated is repressed through the melting of said portion.

20. The generating apparatus as defined in claim 18, wherein a side wall of said cylindrical portion is inclined outwardly from a center axis of said rotating anticathode so that said X-ray can be taken easily out of said target.

21. The generating apparatus as defined in claim 17, wherein said portion to which said energy beams are irradiated is formed in a V-shaped ditch or a U-shaped ditch.

22. The generating apparatus as defined in claim 21, wherein said V-shaped ditch or said U-shaped ditch is formed in the same shape as said centrifugal force affects said portion under melting to which said energy beams are irradiated.

23. The generating apparatus as defined in claim 14, wherein in said target, an area around said portion to which said energy beams are irradiated is made from a substance with higher melting point and/or higher thermal conductivity than a target material contributing the generation of said X-ray.

24. The generating apparatus as defined in claim 17, wherein in said target, an area around said portion to which said energy beams are irradiated is made from a substance with higher melting point and/or higher thermal conductivity than a target material contributing the generation of said X-ray.

25. The generating apparatus as defined in claim 23, wherein said target is a double structured target composed of said target material and said substance with higher melting point and/or higher thermal conductivity than said target material and which is provided at a backside of said target material so that a cooling medium is flowed along said backside of said substance.

26. The generating apparatus as defined in claim 24, wherein said target is a double structured target composed of said target material and said substance with higher melting point and/or higher thermal conductivity than said target material and which is provided at a backside of said target material so that a cooling medium is flowed along said backside of said substance.
